(19) United States
(12) Patent Application Publication
(10) Pub. No.: US 2016/0359989 A1
(43) Pub. Date: Dec. 8, 2016

(54) Recording And Triggering Web And Native Mobile Application Events With Mapped Data Fields

(71) Applicant: UserIQ, Inc., Atlanta, GA (US)

(72) Inventor: Aaron Brent Aycock, Atlanta, GA (US)

(21) Appl. No.: 14/728,801

(22) Filed: Jun. 2, 2015

(51) Int. Cl. H04L 29/08

(52) U.S. Cl. CPC H04L 67/22; H04L 67/02; H04L 67/26

(57) ABSTRACT

Systems and methods are disclosed for tracking and recording web and mobile application events and identifying users of the web or mobile application. A client device receives, on a web browser or mobile application executing on the client device, a web page that includes a tracking script. The tracking script instructs the client device to request configuration parameters from a tracking server. Configuration parameters can indicate types of events that will be tracked by the tracking server as well as the activation of other features, such as form inspection or a record user interface. Upon occurrence of one or more user events corresponding to types of events indicated in the configuration parameters, the client device transmits a push event request to an analytics collection engine. The push event request indicates client attributes such as identifying the web page, the client device, the referring web page.

### TECHNICAL FIELD

This disclosure relates generally to computer-implemented methods and systems for tracking and recording computer events and end user identification for a third party web application.

### BACKGROUND

Conventional methods for tracking third-party web and native mobile application events include adding script code throughout the third-party application that invokes a custom application programming interface (API) to provide specific event details which are typically stored in a tracking server database. Conventional methods for identifying individual users extend methods for tracking events to include unique identifying information for identifying end-users.

The conventional methods for tracking events and uniquely identifying end users present drawbacks due to the custom script code development required. For each event type and user attribute, script code must be added to include the data in subsequent calls to an API. Therefore, with each new event type or user attribute to be tracked, script code must be developed, tested, and deployed which can lead to product release delays and additional costs.

### SUMMARY

The present invention relates to a technique whereby events in a third-party web application delivered to a computer system or mobile application delivered to a mobile device such as a tablet or smartphone can be recorded using a combination of client-side script code and server-side application code. Data captured by the third-party application in the web browser or mobile application during key events, such as new user registration, user login, etc. may be mapped to server-side data fields for user identification and event tracking.

The present invention was conceived in light of the above-mentioned limitations, among other things The present invention provides a technique to record web and native mobile application events in a web browser or native mobile application runtime. Events are recorded by sending an event start signal to the tracking server, executing the desired event (either in the third-party web or native mobile application), sending an event stop signal to the tracking server, then identifying the event type and/or unique event name to be stored on the tracking server. If event data or user attributes are to be captured in the context of the event, then a final step allows the captured data from the third party application to be mapped to tracking server data fields using a visual user interface and stored in a tracking server database.

In some aspects, a method for tracking events and identifying users of a client device is provided. The method includes receiving, at a client device, a web page that includes a tracking script. The tracking script provides instructions for the client device. The method also includes requesting, by the client device in response to the instructions of the tracking script, configuration parameters from a tracking server. The configuration parameters indicate types of events that are to be tracked by the tracking server. Upon occurrence of one or more events that correspond to the types of events indicated in the configuration parameters, the tracking script transmits a push event request to an analytics collection engine. The push event request indicates client attributes that identify the web page, the client device, and the referring web page. The push event request is stored at an analytics database.

In some aspects, the configuration parameters further specify form inspection code. Upon execution by the client device, the form execution code causes the client device to attach an event listener to a form displayed on the web page. The event listener also configures the web page to transmit form field names and form field values entered in the form to the tracking server as part of the push event request.

In further aspects, a method for tracking events and identifying users of a client device is provided. The method includes receiving, at a client device, a web page that includes a tracking script. The tracking script provides instructions for the client device. The client device also includes a user interface for displaying the web page. The method also includes requesting, by the client device in response to the instructions of the tracking script, configuration parameters from a tracking server. The configuration parameters indicate types of events that will be tracked by the tracking server. The configuration parameters further indicate that the client device should display a record user interface on the user interface. The method further includes displaying, by the client device in response to the instructions of the tracking script and the configuration parameters, the record user interface on the user interface. The record user interface includes a record start button and a record stop button. In response to receiving a user input activating the record start button, the client device tracks one or more events corresponding to the types of events indicated in the configuration parameters. Upon occurrence of one or more of the events corresponding to the types of events indicated in the configuration parameters, the method includes transmitting, by the client device in response to the instructions of the tracking script, a push event request to an analytics collection engine. The push event request indicates client attributes identifying the web page, the client device, and the referring web page. The push event request is stored at the analytics database. In response to receiving a user input activating a record stop button, the client device stops the tracking of the one or more events.

These illustrative aspects and features are mentioned not to limit or define the invention, but to provide examples to aid understanding of the inventive concepts disclosed in this application. Other aspects, advantages, and features of the present invention will become apparent after review of the entire application.

### BRIEF DESCRIPTION OF THE FIGURES

These and other features, aspects, and advantages of the present disclosure are better understood when the following Detailed Description is read with reference to the accompanying drawings, where:

FIG. 1 is a block diagram showing an example of a basic configuration of a web system to which the invention may be applied;

FIG. 2 is a block diagram showing an example of a basic configuration of software which runs on a web system to which the invention may be applied;

FIGS. 3a and 3b are flowcharts showing the basic flow of operation of an example of a web application on a web system to which the invention may be applied;

FIG. 4 is a sequence diagram showing an example of a control flow between a client browser, a third-party web server, and a tracking webserver according to certain embodiments of the present invention;

FIG. 5 is a component diagram showing an example of a basic flow of operation for event tracking between a client web browser and a tracking web server according to certain embodiments of the present invention;

FIG. 6 is a component diagram showing an example of a basic flow of operation for event recording between a client web browser and a tracking web server according to certain embodiments of the present invention;

FIG. 7 is a component diagram showing an example of a basic flow of operation for form inspection between a client web browser and a tracking web server according to certain embodiments of the present invention;

FIG. 8 shows an example of a visual data mapping process according to certain embodiments of the present invention;

FIG. 9 is a component diagram showing an example of a basic flow of in-application event triggers according to certain embodiments of the present invention;

FIG. 10 is a component diagram showing a basic flow of operation for native mobile application event recording between a client web browser and a tracking web server, according to certain embodiments of the present invention; and

FIG. 11 is a component diagram showing a basic flow of operation for event tracking between a client web browser using a browser-specific plugin and a tracking web server, according to certain embodiments of the present invention.

### DETAILED DESCRIPTION

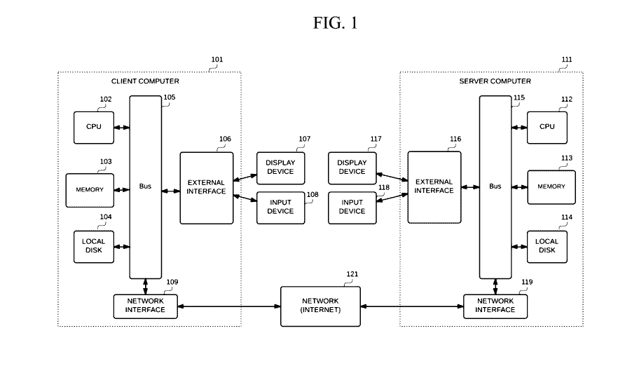

Systems and methods are provided for recording and triggering web and native mobile application events with mapped data fields according to certain embodiments of the present invention will be described with reference to FIGS. 1-9.

FIGS. 1-3 show an exemplary web system to which the present invention may be applied, as well as the configuration of a web application and its basic process flows. In particular, FIG. 1 is a block diagram showing the basic configuration of the exemplary web system. The web system is roughly divided into a client computer 101, a server computer 111, and a network 121 connecting them. Although one client computer 101 and one server computer 111 are shown in FIG. 1, the web system may have two or more client and server computers.

The client computer 101 includes typical components, such as a CPU 102, memory 103, a local disk 104, an external interface 106, a network interface 109, and a bus 105 connecting them. The external interface 106 is connected with peripherals such as a display device 107 and in input device 108. The display device 107 may be a liquid crystal display, as an example. The input device 108 may be a keyboard, a mouse and/or any other suitable type of input device. The server computer 111 has the same basic structure as the client computer 101, with corresponding typical components identified with reference numbers 112-119, respectively. The network interfaces 109, 119 of the client computer 101 and the server computer 111 are connected with the network 121, which may be the Internet, intranet(s) and/or any other types of communication networks. The processors 102, 112 may comprise microprocessors, application-specific integrated circuits, or other processing devices. Processors 102, 112 can each include one processing device or more than one processing device. Processors 102, 112 can each be in communication with a computer-readable medium storing instructions that, when executed by the processors 102, 112, cause the processors to perform operations described herein. For example, memory 103, 113 can be any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

As will be appreciated, a client computer 101 may comprise, for example, any type of processor-based or other computing system. For example, client computer 101 may be embodied in the form of a desktop computer, a laptop computer, a personal digital assistant, a cellular telephone, a set-top box, a music player, a web pad, a tablet computer, a game console, or any other device with like capabilities.

A server computer 111 may be and suitable computing device that executes software for performing server-side functionality in a client-server interaction model. The illustrated server computer 111 may, in practice, be implemented as one or more server banks or computer banks or other arrangements. For example, a plurality servers computers 111 together may comprise a cloud computing resource, a grid computing resource, and/or any other aggregated or distributed computing arrangement. Such server computers 111 may be located in a single installation or may be distributed among many different geographical locations. For purposes of convenience, a server computer 111 may be referred to herein in the singular, but it should be understood that a plurality of server computers 111 may be employed in various arrangements as described above.

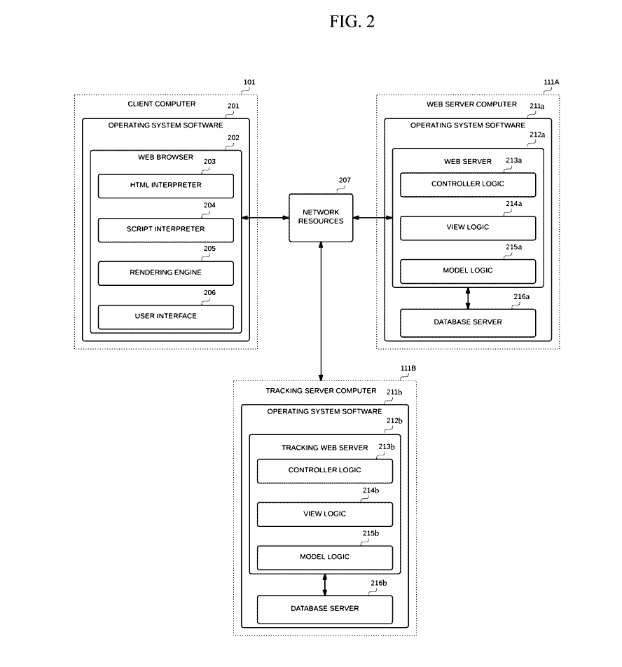

FIG. 2 is a block diagram showing an example of a basic configuration of software that may be run on the exemplary client computer 101 and server computer 111. The exemplary software components that runs on both the client computer 101 and the server computer 111 are similar in that they run within the confines of an operating system 201/211 with underlying support for the network protocols necessary to communicate with the applicable network resources 207. The network resources 207 exposes the network in a way that the client 101 and server computers 201 can reliably exchange data.

On the client computer 101, a web browser 202 is installed and is executed on the operating system 201 stack. The client web browser 202 is comprised of several key components, such as the HTML interpreter 203, the script interpreter 204, the rendering engine 205, and the user interface 206. The HTML interpreter 203 is used to parse the hypertext markup language that is commonly used to define the structure of web content. It will look for key elements to define the structure of the page and delegate work to the script interpreter 204 and rendering engine 205 once the structure of the content is parsed. The script interpreter 204 is presented with executable script code by HTML interpreter 203. In this embodiment, the script can be Javascript client-side interpreted code, meaning it is not compiled before execution.

The rendering engine 205 is used to evaluate all non-script HTML content to render the page as designed. In this embodiment the HTML content may be combined with Cascading Style Sheet (CSS) definitions to determine appearance, order, location, and responsive display rules. The user interface 206 represents the interface presented to the user for interaction including dialogues, menus, buttons, and input fields. These user interface elements include the ‘Home’ button, ‘Back’ button, URL input field, and other elements required to navigate web content.

On the server computers 111A and 111B, the executable code for the operating system and server programs, such as a web server 212a (or tracking web server 212b) and database server 216, is saved in the local disk 114, loaded into memory 113 and executed by the CPU 112. The server program receives a request for a web page from the client computer 101 through the network resources 207 and generates a web page and sends a response to the client computer 101.

Thus, according to certain embodiments of the present invention, a web server 212a provides certain webpages, applications, and/or other data to a requesting web browser 202 or other program executed by a client computer 101. A tracking web server 212b executed by a tracking web server computer 111B (or, in some embodiments, executed by the web server computer 111A) is configured to track and possibly record certain interactions between the web browser 202 or other program executed by client computer 101 and the web server 212a.

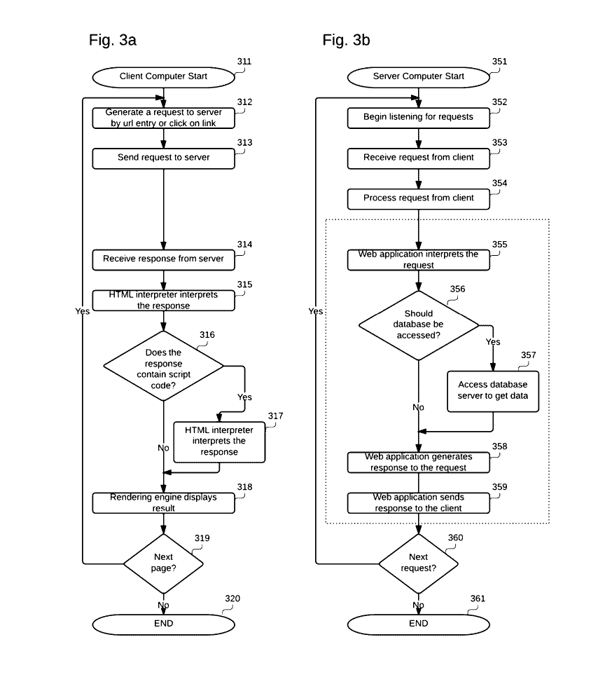

FIGS. 3A-B are flowcharts showing a basic flow of operation of a web application running in a distributed manner on client computer 101 and a server computer 111 in an exemplary web system. FIG. 3A shows the processing sequence of the client computer 101 and FIG. 3B shows that of the server computers 111A and 111B.

First, the basic processing sequence of the client computer 101 will be explained with reference to FIG. 3A. The client computer 101 executes a web browser 202, which generates a request to be sent to the web server computer 111A, such as by the user entering the URL of a web page which the user wishes to access or clicking a link to the web page (Step 312). Then, the client computer 101 sends the generated request to the web server computer 111A (Step 313). As the client computer 101 receives a response (requested web page) from the web server computer 111 (Step 314), the HTML interpreter 203 of the web browser 202 interprets the response (Step 315) and checks whether the response contains script code (Step 316); if so, the script interpreter 204 interprets the code (Step 317). Then, the rendering engine 205 displays the process result on the user interface 206 of the web browser 202 (Step 318). Then, if there is a request for a next web page to be sent to the web server computer 111A, the sequence returns to Step 312. If there is no request for a next web page, the sequence ends at Step 320.

Next, the basic processing sequence of the web server computer 111A will be explained with reference to FIG. 3B. The web server computer 111A executes the web server 212a, which listens for client requests (Step 352). Then, as it receives a request for a web page from the client computer 101 (Step 353), it processes the request (Step 354), including parsing the request address, parameters, and header settings. The web server 212a passes the request parameters to the web application for processing (Step 355). Based on the request, the web application executable code determines whether database access is required (Step 356). If database access is required, the web server 212a will access an applicable database, e.g., via a database server 216a, to retrieve the required data (Step 357). The web server 212a then generates the response to the request (Step 358). The web server 212a then sends the response to the web browser 202 executed by the client computer 101 (Step 359). The web server 212a continues listening for client requests (Step 360) until the web server 212a is eventually shutdown (Step 361).

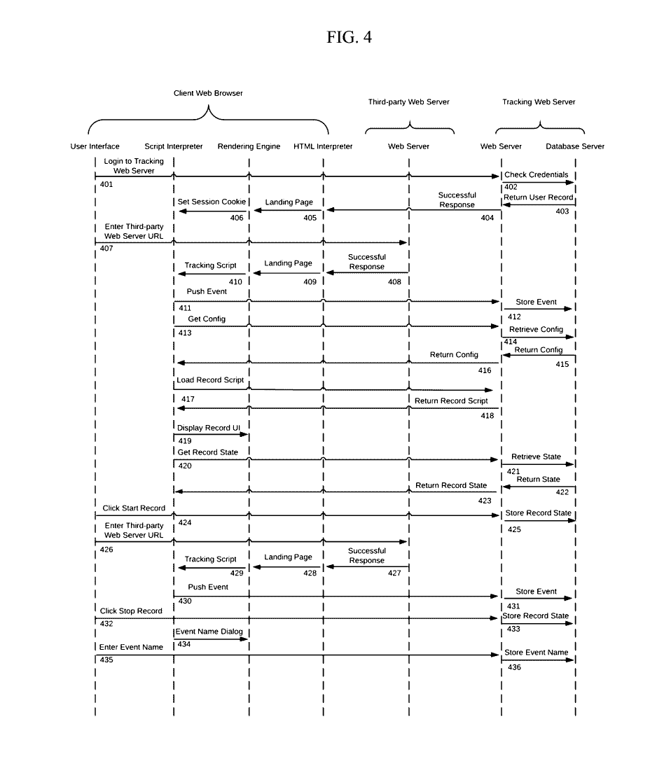

FIG. 4 is a sequence diagram showing an exemplary control flow between a web browser 202 running on a client computer 101, a web server 212 running on a server computer 111a, and a tracking webserver 111b which enables recording events.

First, the web browser 202 initiates the process of establishing a session with the tracking webserver 111b (Step 401). The web browser 202 does so automatically or in response to user input, by sending a login request to the tracking webserver 111b (Step 401). The tracking webserver 111b extracts login credentials (e.g., username/device identifier/password/etc.) and interacts with a database server or other suitable resource to authenticate the credentials (Step 402). The tracking webserver 111b then receives a user record (Step 403) associated with the login credentials which associates a user with an authorized account. Upon authenticating the user, the tracking webserver 111b provides notice of the successful login to the web browser 202 (Step 404), which is received by the HTML interpreter 203. The HTML interpreter 203 then generates a landing page and passes it to the rendering engine 205 (Step 405), which sets a session cookie and passes it to the script handler 204 (Step 406).

Next, within the web browser 202 the user enters a URL for a webpage in the address bar or otherwise activates a link to that web page from the web server 111a (Step 407). The third-party web server 111a returns a webpage in the response (408-409). In this embodiment, the webpage contains a client-side tracking script. The client-side tracking script is written in JAVASCRIPT or other scripting language and is interpreted (Step 410) by the script interpreter 204 of the web browser 202. The tracking script includes instructions for the web browser 202 to request configuration parameters using a GetConfig server request (Step 413) via JSONP or CORS, which allows cross-domain requests with result payloads. The GetConfig request includes the Site ID which is embedded in the tracking script. The tracking web server 212b responds with configuration parameters as set for the specified Site ID (Steps 414-416). Once configuration parameters are established, the tracking code will evaluate the current page, determine if it is a page that requires form inspection, or additional in-application events then push the appropriate event with a Push Event request (Step 417).

Configuration parameters can control the type of data that is provided between the tracking server computer 111b. In some aspects, configuration parameters can include information indicating the types of events that should be delivered/displayed from the tracking server computer 111b to the end user by the client computer 101. For example configuration parameters may return data from the tracking server computer 111b that indicates a message should be displayed to the end user by the client computer 101. Upon execution, the tracking script will display the message to the end user.

The configuration parameters also determine which events need to be tracked and sent to the tracking server computer 111b. For example, configuration parameters may return data that indicate that all mouse clicks on a particular element on a web page need to be tracked. Upon execution, the tracking script will cause the web browser 202 to track any click on the specified element and send the event data for the click to the tracking server computer 111b.

In the example shown in FIG. 4, the configuration response from the tracking web server 212b indicates that the record event user interface should be presented to the user. In this case, the event record script is interpreted by the web browser 202 (Step 418). The record event user interface is rendered by the web browser rendering engine 205, as instructed by the script interpreter 204, which is interpreting the instructions provided by the event record script (Step 419).

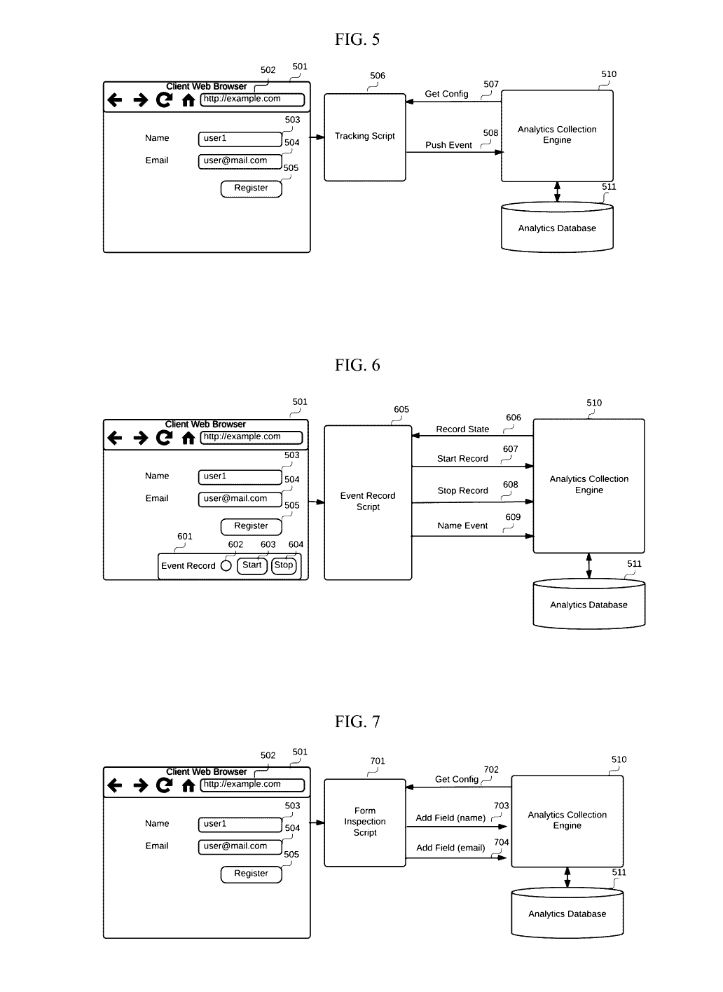

The record event user interface 601 includes several elements that enable event recording. First, the event record status icon 602 presents a visual indication of the record state and may be displayed as a skeuomorphic representation of a single, red LED bulb. It has 2 states-active and inactive. The active state resembles a lit LED bulb. The inactive state resembles an unlit LED bulb. The initial state of the record status icon is provided by the record state response from the tracking web server 212b (Steps 420-423). If true, the record status icon is active. Otherwise the record status icon is inactive. The record start button 603 toggles the state of an inactive event record icon, and sends a start record request (Steps 424-425). Once the record status is active, the user may enter the desired URL or click the desired link to generate the appropriate event, which is pushed as described in FIG. 5 (Step 426-429).

The process to push the appropriate event begins with the browser 202 reading the visitor_id cookie, or creating the cookie with a unique value if it doesn't exist. Next, the tracking code evaluates the referring url, current page url, and page name, among other client attributes and generates a URL that passes these attributes in a push event that resembles a simple HTTP get request for an image (Step 430). This is often referred to as a tracking pixel request, but will be referred to in this invention as the push event request. The push event request is sent to the analytics collection engine, which is running on the tracking web server computer 111B. The site_id, visitor_id, tracking cookie value, url, page name, referring url, and all other client attributes are parsed by the analytics collection engine running on the tracking web server computer 111B. The tracking web server 212b executes logic to add identifying information based on the visitor and site IDs. It also executes logic to associate the current visit action to the appropriate visit, which belongs to a visitor. The tracking web server 212b then passes the data to the analytics database for storage (Step 431).

Once the appropriate event has been captured, the user may click the event record stop button 604 in the event record user interface 601 (Step 432-433). This will trigger the stop record server request and will render the Event Name modal dialog (Step 434). The event name modal dialog is used to capture the event name and will send the entered name to the analytics collection engine using the name event request, which in this embodiment is sent via JSONP or CORS (Step 435). The event name is parsed and is associated with the pushed events captured since the start record request was received. This data is then persisted in the analytics database and the record event process is complete (Step 436).

FIG. 5 is a component diagram showing the basic flow of operation for event tracking between the client web browser 202 and the tracking webserver 212b. The flow begins with a user launching a web browser client 202 and entering a URL for a webpage in the address bar 502 or otherwise activating a link to that webpage. In this embodiment, the web page contains a client-side tracking script 506. The client-side tracking script 506 is written in JAVASCRIPT and is interpreted by the script interpreter of the web browser 501. The tracking script 506 includes instructions for the web browser 501 to request configuration parameters using a GetConfig server request 507 via JSONP or CORS, which allows cross-domain requests with result payloads. The GetConfig request 507 includes the Site ID which is embedded in the tracking script 506. The tracking webserver 212b responds with configuration parameters as set for the specified Site ID. Once configuration parameters are established, the tracking script 506 will evaluate the current page, determine if it is a page that requires form inspection, then push the appropriate event with a Push Event request 508. The process to push the appropriate event begins with the web browser 501 reading the visitor id cookie, or creating the cookie with a unique value if it doesn't exist. Next, the tracking script 506 evaluates the referring url, current page url 502, and page name, among other client attributes and generates a URL that passes these attributes in a push event that resembles a simple HTTP get request for an image. This is often referred to as a tracking pixel request, but will be referred to in this invention as the push event request 508. The push event request 508 is sent to the analytics collection engine 510, which is running on the tracking web server computer 111B. The site id, visitor id, tracking cookie value, url, page name, referring url, and all other client attributes are parsed by the analytics collection engine 510 running on the tracking web server computer 111B. The analytics collection engine 510 executes logic to add identifying information based on the visitor and site IDs. It also executes logic to associate the current visit action to the appropriate visit, which belongs to a visitor. The analytics collection engine 510 then passes the data to the analytics database 511 for storage. In this embodiment, the analytics database 511 can be a relational database with disk-based data stores. Other embodiments could involve in-memory databases, data stores based on key-value pairs, columnar databases, file-based data stores, or data bases that are distributed and/or optimized for high performance storage and retrieval.

FIG. 6 is a component diagram showing the basic flow of operation for event recording between the client web browser 501 and the tracking web server 212b with the added process of recording the event and assigning a unique name for the event.

The flow begins with a user launching a web browser client 501 and entering a URL for a webpage in the address bar 502. In this embodiment, the web page contains a client-side tracking script 506. The client-side tracking script 506 is written in JAVASCRIPT and is interpreted by the script interpreter of the web browser 501. The tracking script 506 includes instructions for the web browser 501 to request configuration parameters using a GetConfig server request 507 via JSONP or CORS, which allows cross-domain requests with result payloads. The GetConfig request 507 includes the Site ID which is embedded in the tracking script 506. The server responds with configuration parameters as set for the specified Site ID. Once configuration parameters are established, the tracking code 506 will evaluate the current page, determine if it is a page that requires form inspection, or additional in-application events then push the appropriate event with a Push Event request 508. In this embodiment, the configuration response from the analytics collection engine indicates that the record event user interface 601 should be presented to the user. In this case, the event record script 605 is interpreted by the web browser. The record event user interface 601 is rendered by the web browser 501 rendering engine, as instructed by the script interpreter, which is interpreting the instructions provided by the event record script 605.

The record event user interface 601 includes several elements that enable event recording. First, the event record status icon 602 present a visual indication of the record state and is a skeuomorphic representation of a single, red LED bulb. It has 2 states-active and inactive. The active state resembles a lit LED bulb. The inactive state resembles an unlit LED bulb. The initial state of the record status icon 602 is provided by the record state response 606 from the analytics collection engine 510. If true, the record status icon is active. Otherwise the record status icon is inactive. The record start button 603 toggles the state of an inactive event record icon 602, and sends a start record request 607. Once the record status is active, the user may enter the desired URL or click the desired link to generate the appropriate event, which is pushed as described in FIG. 5.

The process to push the appropriate event begins with the browser 501 reading the visitor id cookie, or creating the cookie with a unique value if it doesn't exist. Next, the tracking code evaluates the referring url, current page url 502, and page name, among other client attributes and generates a URL that passes these attributes in a push event that resembles a simple HTTP get request for an image. This is often referred to as a tracking pixel request, but will be referred to in this invention as the push event request 508. The push event request 508 is sent to the analytics collection engine 510, which is running on the tracking web server. The site id, visitor id, tracking cookie value, url, page name, referring url, and all other client attributes are parsed by the analytics collection engine 510 running on the tracking web server. The analytics collection engine 510 executes logic to add identifying information based on the visitor and site IDs. It also executes logic to associate the current visit action to the appropriate visit, which belongs to a visitor. The analytics collection engine 510 then passes the data to the analytics database 511 for storage.

Once the appropriate event has been captured, the user may click the event record stop button 604 in the event record user interface 601. This will trigger the stop record server request 608 and will render the Event Name modal dialog. The event name modal dialog is used to capture the event name and will send the entered name to the analytics collection engine using the name event request 609, which in this embodiment is sent via JSONP or CORS. The event name is parsed and is associated with the pushed events captured since the start record request was received. This data is then persisted in the analytics database 511 and the record event process is complete.

FIG. 7 is a component diagram showing the basic flow of operation for form inspection between the client web browser 501 and the tracking web server 212b.

The flow begins with a user launching a web browser client 501 and entering a URL for a webpage in the address bar 502. In this embodiment, the web page contains a client-side tracking script 506. The client-side tracking script 506 is written in JAVASCRIPT and is interpreted by the script interpreter of the web browser 501. The tracking script 506 includes instructions for the web browser 501 to request configuration parameters using a GetConfig server request 507 via JSONP or CORS, which allows cross-domain requests with result payloads.. The GetConfig request 507 includes the Site ID which is embedded in the tracking script 506. The tracking web server 212b responds with configuration parameters as set for the specified Site ID.

In this embodiment, the tracking web server 212b responds with configuration parameters that indicate form inspection is required. The browser 501 script interpreter will interpret the form inspection code 701 as instructed. The form inspection script 701 adds several key steps to the event tracking process described in FIG. 5. First, it adds a listener to each form on the web page, which allows it to perform tasks before the submission of the form. Second, it adds an event listener that gathers each form field and form field value in the form at the time of submission. Third, it cancels the current form submission request and sends the form field names and values to the tracking web server 212b using individual Add Field requests 703/704. These requests are sent to the Analytics Collection Engine 510. Upon successful Add Field request 703/704 completion, the postponed form submission will be allowed to continue.

The browser 501 will then proceed with standard event tracking as described in FIG. 5 and push the appropriate event with a Push Event request 508. The process to push the appropriate event begins with the browser reading the visitor id cookie, or creating the cookie with a unique value if it doesn't exist. Next, the tracking code evaluates the referring url, current page url 502, and page name, among other client attributes and generates a URL that passes these attributes in a push event that resembles a simple HTTP get request for an image. This is often referred to as a tracking pixel request, but will be referred to in this invention as the push event request 508. The push event request 508 is sent to the analytics collection engine 510, which is running on the tracking web server. The site id, visitor id, tracking cookie value, url, page name, referring url, and all other client attributes are parsed by the analytics collection engine 510 running on the tracking web server 212b. The analytics collection engine 510 executes logic to add identifying information based on the visitor and site IDs. It also executes logic to associate the current visit action to the appropriate visit, which belongs to a visitor. The analytics collection engine 510 then passes the data to the analytics database 511 for storage.

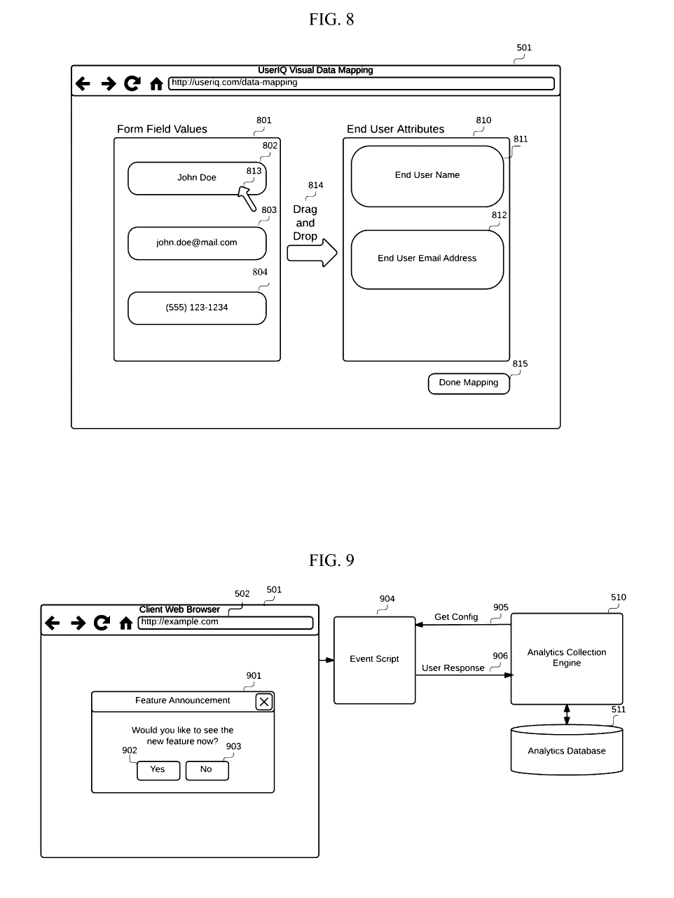

FIG. 8 shows an example of the visual data mapping process. The flow begins after an event recording with active form inspection has been completed. The visual data mapping user interface is rendered by the client browser. The user interface consists of captured user form fields, grouped in the form field values container 801 and drop zones, grouped in the mapped data field attributes container 810. In this embodiment, the example data fields include user name 802, user email 803, and phone number 804. The user interface allows for the user field values to be clicked using the cursor 813, dragged, and dropped into the corresponding drop zones (e.g., 811, 812) of the mapped data field container 810. Once the user has successfully mapped the name field 802 and email field 803 to the end user name 811 and end user email address 812 drop zones, they may click on the completed map submission button 815 to end the process.

FIG. 9 is a component diagram showing the basic flow of in-application event triggers. The flow begins with a user launching a web browser client 501 and entering a URL for a webpage in the address bar 502. In this embodiment, the web page contains a client-side tracking script 506. The client-side tracking script 506 is written in JAVASCRIPT and is interpreted by the script interpreter of the web browser 501. The tracking script 506 includes instructions for the web browser 501 to request configuration parameters using a GetConfig server request 507 via JSONP or CORS, which allows cross-domain requests with result payloads. The GetConfig request 507 includes the Site ID which is embedded in the tracking script 506. The server responds with configuration parameters as set for the specified Site ID. Once configuration parameters are established, the tracking code 506 will evaluate the current page, determine if it is a page that requires form inspection or in this embodiment, an in-application event trigger. The in-application event trigger can take many forms. In this embodiment it is an in-application modal dialog user interface 901 that can present a titled window 901, custom text, and a set of buttons 902/903. The content of the dialog box 901 is determined by the Get Config server response 905. Other embodiments might include in-application alerts that are anchored to a specific location on screen, in-application survey forms, in-application advertising, or in-application messaging in the form of dynamic HTML content that replaces existing HTML content. The in-application is rendered by the browser 501 rendering engine, and the behavior is controlled by the script interpreter which is directed by the event script 904. In this case, the event script 904 is listening for a response by the user, who may click the affirmative response 902 or the negative response 903. The event script then pushes the user response to the server using the User Response request 906.

Web pages that trigger in-application events end with a Push Event request as described in FIG. 5. The process to push the appropriate event begins with the browser reading the visitor_id cookie, or creating the cookie with a unique value if it doesn't exist. Next, the tracking code evaluates the referring url, current page url 502, and page name, among other client attributes and generates a URL that passes these attributes in a push event that resembles a simple HTTP get request for an image. This is often referred to as a tracking pixel request, but will be referred to in this invention as the push event request 508. The push event request 508 is sent to the analytics collection engine 510, which is running on the tracking web server. The site id, visitor id, tracking cookie value, url, page name, referring url, and all other client attributes are parsed by the analytics collection engine 510 running on the tracking web server. The analytics collection engine 510 executes logic to add identifying information based on the visitor and site IDs. It also executes logic to associate the current visit action to the appropriate visit, which belongs to a visitor. The analytics collection engine 510 then passes the data to the analytics database 511 for storage. In this embodiment, the analytics database 511 can be a relational database with disk-based data stores.

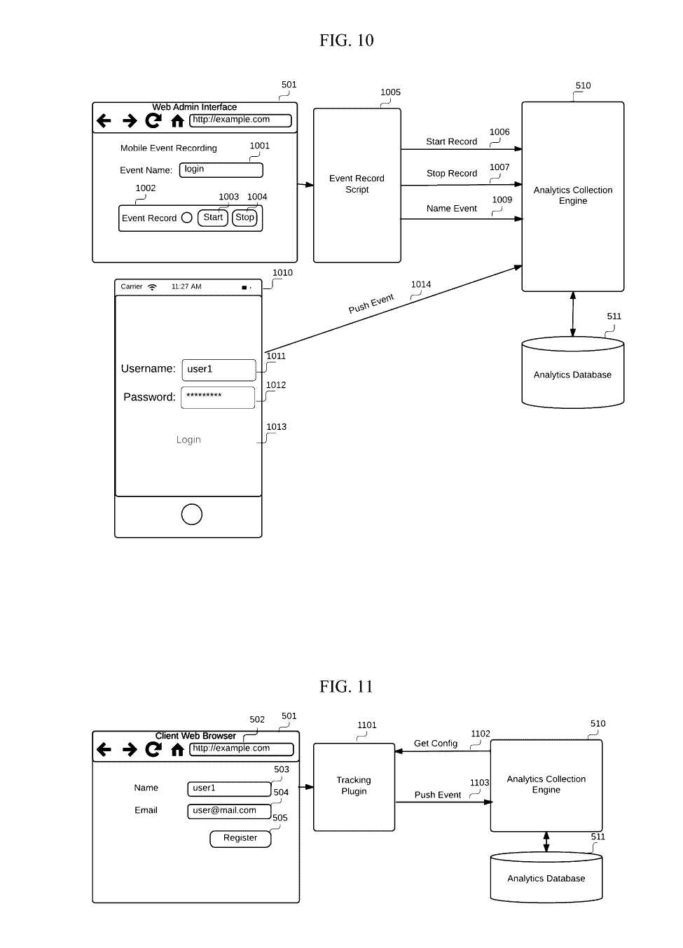

FIG. 10 is a component diagram showing the basic flow of operation for native mobile application event recording between a client web browser and a tracking web server. The flow begins with a user launching a web browser client 501 and entering a URL for the record native mobile event control page in the address bar 502. In this embodiment, the configuration response from the analytics collection engine indicates that the mobile record event user interface 1002 should be presented to the user. In this case, the event record script 1005 is interpreted by the web browser. The native mobile application record event user interface 1002 is rendered by the web browser 501 rendering engine, as instructed by the script interpreter, which is interpreting the instructions provided by the event record script 1005.

The record event user interface 1002 includes several elements that enable event recording. First, the event record status icon 1100 present a visual indication of the record state and is a skeuomorphic representation of a single, red LED bulb. It has 2 states-active and inactive. The active state resembles a lit LED bulb. The inactive state resembles an unlit LED bulb. The initial state of the record status icon 1100 is provided by the record state response from the analytics collection engine 510. If true, the record status icon is active. Otherwise the record status icon is inactive. The record start button 1003 toggles the state of an inactive event record icon 1100, and sends a start record request 1106. Once the record status is active, may perform the desired action on the mobile device 1010, such as completing a login by entering the username 1011, password 1012, and tapping the login button 1013. The process to push the appropriate native mobile application event resembles the push event request 508 from FIG. 5, but is implemented in native mobile code for execution. In this embodiment, the native mobile application code could be Objective-C for Apple iOS mobile devices, or Java for Android mobile devices. The push event request 1014 is sent to the analytics collection engine 510, which is running on the tracking web server. The site_id, visitor_id, tracking cookie value, url, page name, referring url, and all other client attributes are parsed by the analytics collection engine 510 running on the tracking web server. The analytics collection engine 510 executes logic to add identifying information based on the visitor and site IDs. It also executes logic to associate the current visit action to the appropriate visit, which belongs to a visitor. The analytics collection engine 510 then passes the data to the analytics database 511 for storage.

Once the appropriate event has been captured, the user may click the event record stop button 1004 in the event record user interface 1002. This will trigger the stop record server request 1007 and will render the Event Name modal dialog. The event name modal dialog is used to capture the event name and will send the entered name to the analytics collection engine using the name event request 1009. The event name is parsed and is associated with the pushed events captured since the start record request was received. This data is then persisted in the analytics database 511 and the record event process is complete.

FIG. 11 is a component diagram showing the basic flow of operation for event tracking between the client web browser using a browser-specific plugin and the tracking web server. The flow is similar to FIG. 5, with the exception that the tracking code isn't included in the third-party web page. Instead, the tracking code is included in a browser-specific plugin or extension 1101. However, the flow is roughly the same and begins with a user launching a web browser client 501 and entering a URL for a webpage in the address bar 502. In this embodiment, the web browser specific plugin or extension 1101 contains the tracking code to be interpreted. The client-side tracking plugin 1101 is written in JAVASCRIPT and is interpreted by the script interpreter of the web browser 501. The tracking plugin 1101 includes instructions for the web browser 501 to request configuration parameters using a GetConfig server request 1102 via JSONP or CORS, which allows cross-domain requests with result payloads. The GetConfig request 1102 includes the Site ID which is embedded in the tracking plugin 1101. The server responds with configuration parameters as set for the specified Site ID. Once configuration parameters are established, the tracking plugin 1101 will evaluate the current page, determine if it is a page that requires form inspection, then push the appropriate event with a Push Event request 1103.

The process to push the appropriate event begins with the browser reading the visitor id cookie, or creating the cookie with a unique value if it doesn't exist. Next, the tracking code evaluates the referring url, current page url 502, and page name, among other client attributes and generates a URL that passes these attributes in a push event that resembles a simple HTTP get request for an image. This is often referred to as a tracking pixel request, but will be referred to in this invention as the push event request 1103. The push event request 1103 is sent to the analytics collection engine 510, which is running on the tracking web server. The site id, visitor id, tracking cookie value, url, page name, referring url, and all other client attributes are parsed by the analytics collection engine 510 running on the tracking web server. The analytics collection engine 510 executes logic to add identifying information based on the visitor and site IDs. It also executes logic to associate the current visit action to the appropriate visit, which belongs to a visitor. The analytics collection engine 510 then passes the data to the analytics database 511 for storage. In this embodiment, the analytics database 511 can be a relational database with disk-based data stores. Other embodiments could involve in-memory databases, data stores based on key-value pairs, columnar databases, file-based data stores, or data bases that are distributed and/or optimized for high performance storage and retrieval.

An implementation of the embodiment shown in FIG. 1 can include a web-based language capable of interpreting HTTP POST and GET requests and responding with HTTP payloads that include HTML, CSS, Javascript and images. The implementation can also include a relational database backend to persist profile, configuration, and operational data.

Data Model

Account (id, name, site_id)

The account record captures important account-level information. It serves as the container for all users, sites, and visitors. These objects are tied together by the site_id, which is a unique identifier for the third-party web site to be tracked.

User (id, first_name, last_name, email, password, login_count, last_login, recording_flag, site_id)

The user record captures important data to uniquely identify each user. Users are members of an account, and contain identifying information (i.e. user ID, first name, last name, email address, salted hash password, login count, etc.). Users are tied to authorized sites by the site_id attribute. The user record also stores the recording state (recording_flag).

Site (account_id, site_id, feature_master, feature_recording, feature_forms)

The site record captures configuration details for each tracked site. All features except for standard event tracking can be enabled/disabled using the feature flags in the site record. For example setting the feature forms flag to false will disable form inspection for an entire site.

Visitor (visitor_id, site_id, account_id, visitor_fname, visitor_lname, visitor_email, first_visit, last_visit, online_now, cookie_id, customer_account_id)

A visitor record is created with each unique browser or native mobile session created. For web application sessions, a unique cookie will be generated by the client-side javascript code. This cookie will be presented to the tracking server on each event. The cookie is persisted between sessions. The visitor record may be updated with identifying attributes, such as _fname, visitor_lname, and visitor_email. Each visitor is tied to site_id and, optionally, customer_account_id. Visitor records can also be updated to reflect if the session is currently active (online_now flag).

Visit (site_id, visitor_id, visit_entry, visit_exit, visit_count, visit_elapsed_time, visit_start, visit_end)

A visit record represents a user session and will typically reference multiple VisitActions.

VisitAction (site_id, visitor_id, url, name, url_hash, visit_id)

A VisitAction record represents a single event during a visitor session (visit). This can represent a page view with a url and a page name. A url hash may be generated for easy comparison to known urls and reduced storage space usage. VisitActions belong to a Visit, and are related by the visit id.

UserField (account_id, user_id, visitor_id, field_name, field_value, site_id, form_url)

UserField records capture field_names and field_values for forms that are inspected by the form inspection client script. For each inspected form, both the field_name and field_values are passed for each field to the tracking server. If a recording session is active, the UserField records will be used for data mapping. If a recording session is not active, the fields may be used for identifying a known-user (through the LoginMap) or triggering an event from a watched field value.

LoginMap(account_id, site_id, form_url, username_field)

The LoginMap record is created to specify the login form url and username_field name so that the UserMap list can be searched for an identified user. The LoginMap is specific to a site_id.

UserMap (account_id, site_id, username_value, frame, lname, email, customer_account_id)

If a VisitAction includes a form_url that is listed in the LoginMap for this site, the value found by inspecting the username field will be passed to the tracking server. The UserMap will be searched for this value (in the username_value field). If a record is found to have matching criteria, then the Visitor record will be updated with the user attributes populated in the UserMap (such as first name, last name, and email address).

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification, discussions utilizing terms such as “processing,” “computing,” “calculating,” “determining,” and “identifying” or the like refer to actions or processes of a computing device, such as one or more computers or a similar electronic computing device or devices, that manipulates or transforms data represented as physical electronic or magnetic quantities within memories, registers, or other storage devices, transmission devices, or display devices of the computing platform.

The system or systems discussed herein are not limited to any particular hardware architecture or configuration. A computing device can include any suitable arrangement of components that provide a result conditioned on one or more function calls. Suitable computing devices include multipurpose microprocessor-based computer systems accessing stored software that programs or configures the computing system from a general-purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device.

Aspects of the methods disclosed herein may be performed in the operation of such computing devices. The order of the blocks presented in the examples above can be varied; for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific aspects thereof, it will be appreciated that those skilled in the art, upon attaining an understanding of the foregoing, may readily produce alterations to, variations of, and equivalents to such aspects. Accordingly, it should be understood that the present disclosure has been presented for purposes of example rather than limitation and does not preclude inclusion of such modifications, variations, and/or additions to the present subject matter as would be readily apparent to one of ordinary skill in the art.

1. A method for tracking events and identifying users of a client device, the method comprising:
receiving, at a client device, a web page that includes a tracking script, wherein the tracking script provides instructions for the client device;
requesting, by the client device in response to the instructions of the tracking script, configuration parameters from a tracking server, the configuration parameters indicating types of events to be tracked by the tracking server; and
upon occurrence of one or more events corresponding to the types of events indicated in the configuration parameters, transmitting by the tracking script, a push event request to an analytics collection engine, the push event request indicating client attributes identifying the web page, the client device, and a referring web page, wherein the push event request is stored at an analytics database.

2. The method of claim 1, wherein the configuration parameters further specify form inspection code that, upon execution by the client device, causes the client device to attach an event listener to a form displayed on the web page, the event listener configuring the web page to transmit form field names and form field values entered in the form to the tracking server as part of the push event request.

3. A method for tracking events and identifying users of a client device, the method comprising:
receiving, at a client device, a web page that includes a tracking script, wherein the tracking script provides instructions for the client device, the client device including a user interface for displaying the web page;
requesting, by the client device in response to the instructions of the tracking script, configuration parameters from a tracking server, the configuration parameters indicating types of events that will be tracked by the tracking server and further indicating that the client device should display a record user interface on the user interface;
displaying, by the client device in response to the instructions of the tracking script and the configuration parameters, the record user interface on the user interface, the record user interface including a record start button and a record stop button;
in response to receiving a user input activating the record start button, tracking, by the client device, one or more events corresponding to the types of events indicated in the configuration parameters;
upon occurrence of one or more of the events corresponding to the types of events indicated in the configuration parameters, transmitting by the client device in response to the instructions of the tracking script, a push event request to an analytics collection engine, the push event request indicating client attributes identifying the web page, the client device, and a referring web page, wherein the push event request is stored at an analytics database; and
in response to receiving a user input activating the record stop button, stopping, by the client device, the tracking of the one or more events.
